(19) United States
(12) Patent Application Publication
(10) Pub. No.: US 2008/0300058 A1
(43) Pub. Date: Dec. 4, 2008

(54) Electronic Gaming Device and System with Player Preference Options

(76) Inventors: Benny Sum, Las Vegas, NV (US); Michael F. Dreitzer, Las Vegas, NV (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/757,957

(22) Filed: Jun. 4, 2007

(51) Int. Cl. A63F 13/12; A63F 13/00; A63F 9/24; A63F 13/10

(52) U.S. Cl. 463/42; 463/16; 463/25; 463/43

(57) ABSTRACT

Described is a electronic gaming device and system with player preference options. With the device or system, a player may select certain game parameters, including, but not limited to, whether or not to play for a progressive jackpot, whether or not to listen to game tones associated with the game and whether or not to play left handed or right handed. Players may also select a number of pay lines to play or which bonus games to play. The player's preferred parameters may then be stored such that during a later visit, the electronic gaming device may be automatically configured using the stored parameters or alternatively, the player may be provided with the option to select or decline the preferred parameters from a previous gaming session. In one version, multiple games of chance may be played simultaneously on a single game screen.

### FIELD OF THE INVENTION

The embodiments of the present invention relate generally to electronic gaming devices (e.g., slot machines). More particularly, the embodiments of the present invention relate to gaming devices providing players with multiple options to customize the players' gaming experience.

### BACKGROUND

Electronic gaming devices, like slot machines, video poker machines and keno machines, have taken over casinos and now account for almost 70% of the gaming revenues generated by a casino. Game manufacturers continue to develop machines with new themes, progressive jackpots, bonus games and other features intended to attract new players and retain existing players. One primary objective of any new electronic gaming device or machine is to entice players to play them for longer periods of time. While new game themes may help extend gaming sessions, the gaming experience associated with playing the machine is also important.

Thus, there is a need for an electronic gaming device and system that permits players to customize the gaming experience associated with a particular gaming device or machine.

### SUMMARY

Accordingly, one embodiment of the present invention is an electronic gaming device for playing a game of chance comprising: a processor operable to control a game of chance; means for permitting players to select certain preferred parameters associated with playing the game of chance on the electronic gaming device; and storage means in communication with the electronic gaming device wherein the storage means is operable to store selected preferred parameters; and wherein the electronic gaming device may be automatically configured during each subsequent gaming session based on stored selected preferred parameters from a previous gaming session.

A system embodiment of the present invention comprises: a plurality of linked electronic gaming devices; means for permitting players to select certain preferred parameters associated with playing a game of chance on any one of the electronic gaming devices; storage means in communication with each electronic gaming device wherein the storage means is operable to store selected preferred parameters; and wherein the electronic gaming devices can be automatically configured during each subsequent gaming session based on stored selected preferred parameters from a previous gaming session.

A method embodiment of the present invention comprises: offering a game of chance via an electronic gaming device; permitting players to select certain preferred parameters associated with playing the game of chance on the electronic gaming device; storing selected preferred parameters associated with the players; and causing the electronic gaming device to be automatically configured during each subsequent gaming session based on stored selected preferred parameters from a previous gaming session.

In this manner, a player may select certain game parameters, including, but not limited to, whether or not to play for a progressive jackpot, whether or not to listen to game tones associated with the game and whether or not to play left handed or right handed. Players may also select a number of pay lines to play or which bonus games to play. The player's preferred parameters may then be stored such that during a future gaming session, the electronic gaming device may be automatically configured to the stored parameters or alternatively, the player may have the option to select or decline the preferred parameters from a previous gaming session.

Other variations, embodiments and features of the present invention will become evident from the following detailed description, drawings and claims.

### BRIEF DESCRIPTION OF THE DRAWINGS

FIG. 1 illustrates a conventional electronic gaming device in the form of a video poker machine;

FIG. 2 illustrates a block diagram of a system of networked multiple electronic gaming devices;

FIGS. 3a-3g illustrate a series of exemplary screen shots whereby a player may select certain preferred game parameters; and

FIG. 4 illustrates a game screen with two slot games displayed simultaneously.

### DETAILED DESCRIPTION

For the purpose of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

The operation of slot machines, video poker machines, keno machines and the like are controlled by microprocessors which communicate with internal memory devices and the external features of the machines. The microprocessors also incorporate, or communicate with, a random number generator which ensures the randomness of the machines' outcomes. Since the technology for operating and controlling electronic gaming machines is well known to those skilled in the art, the subtle operational details are not described herein.

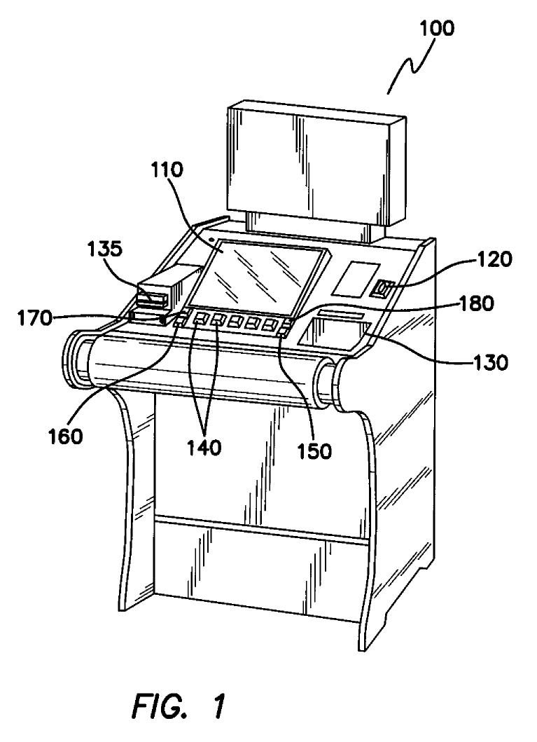

Reference is now made to the figures wherein like parts are referred to by like numerals throughout. FIG. 1 illustrates an exemplary video poker machine generally referred to by reference numeral 100. The machine 100 includes a display 110, coin input 120, bill or coupon acceptor 130, card reader 135 and interface buttons, including hold/discard buttons 140, deal/draw button 150, cash out button 160, bet one coin button 170 and bet max coins button 180. In lieu of, or in addition to, all operations achieved using the interface buttons may be accomplished via touch screen technology.

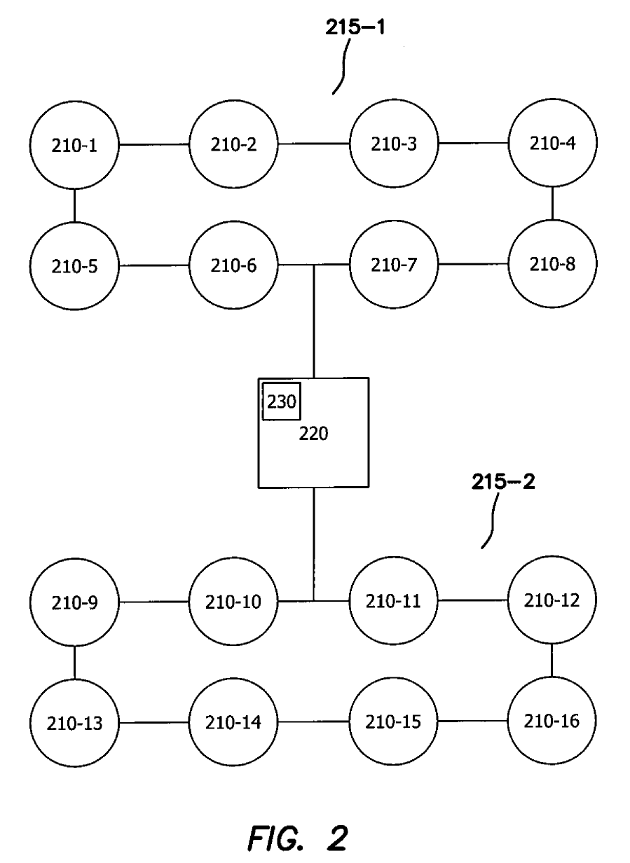

FIG. 2 shows a block diagram of a gaming network generally denoted by reference numeral 200. The gaming network 200 comprises a plurality of electronic gaming devices 210-1 through 210-16 and a central computer, processor and/or server 220. As shown, the gaming devices 210-1 through 210-16 form two banks 215-1, 215-2 of devices. However, in practice more than two banks of devices can be linked to a common server. In this configuration, the server 220 may communicate with a bank router device or a bank processor as well. Alternatively, each device 210-1 through 210-16 may be in direct communication with the server 220. Multiple servers may also be part of the configuration. A player tracking system 230, facilitated by computer software, runs on the central server 220. The player tracking system 230 tracks gaming sessions of registered players. In a majority of instances, registered players are issued players' or slot club cards. The cards include a magnetic stripe which stores player-related information. Prior to the start of any gaming session, a player inserts his or her card into card readers incorporated on the electronic gaming devices 210-1 through 210-16. Upon insertion, the player's information is read by the card reader and a corresponding player database stored on the central server 220 or elsewhere is accessed. In some systems, the player tracking system causes a player greeting (e.g., “HELLO BOB”) to be transmitted to a small multi-segment, LED, LCD or similar type display on the electronic gaming device. Once the gaming session terminates, information from the new gaming session is aggregated with prior gaming session information and the updated aggregated information is stored in the player's database. Player tracking systems and their corresponding operations are well known to those skilled in the art.

One purpose of gathering the gaming session information is to allow the casino to market to players based on the players' playing habits. Casino marketing includes direct solicitations and providing comps and related amenities to maintain existing players and to attract new players. Player tracking systems may gather player information from a single casino property or multiple commonly-owned casino properties.

The embodiments of the present invention focus on electronic gaming devices having parameters or features that can be customized by players prior to a gaming session so that the gaming experience is heightened for the players. In addition, the selected player parameters are stored such that they are automatically configured, or offered to players, during each subsequent gaming session.

Slot machines, video poker machines and keno machines have certain attributes that may or may not be appealing to players. Also, they have certain game functions that are optional for players. It would be advantageous to permit players to select game attributes and functions prior to game play and to further store the selections for future use.

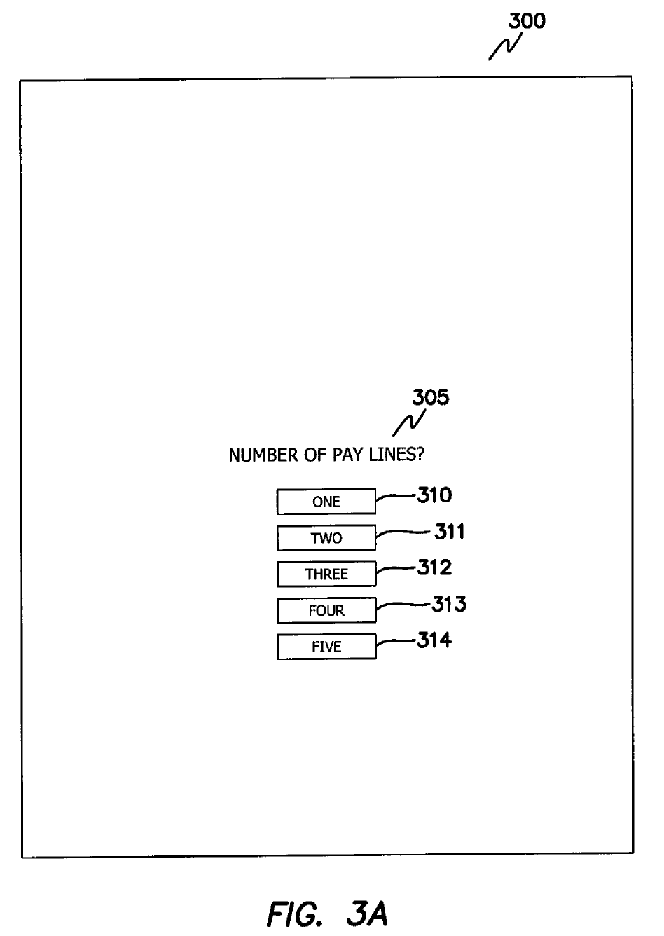

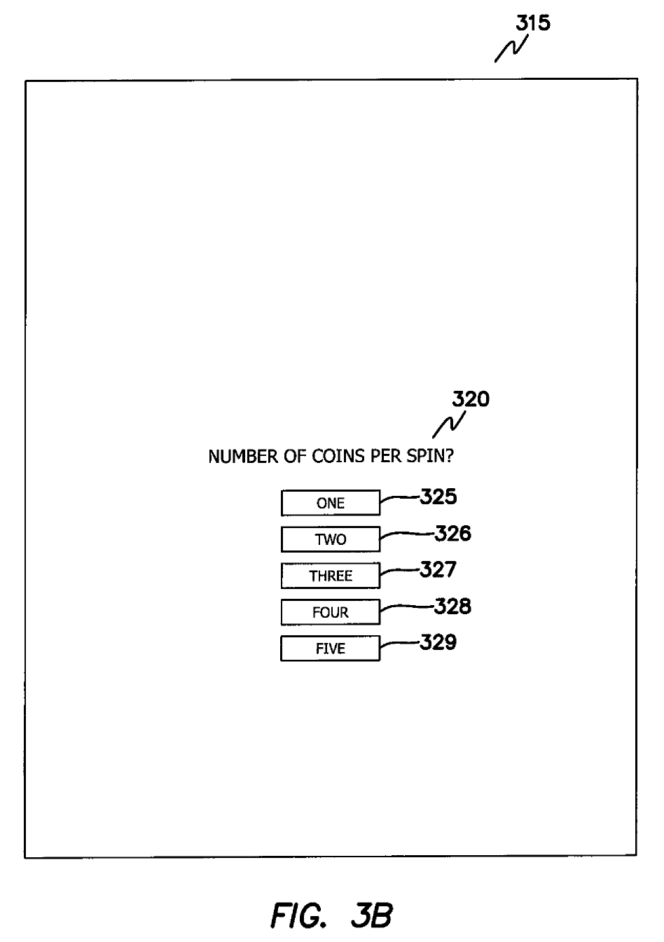

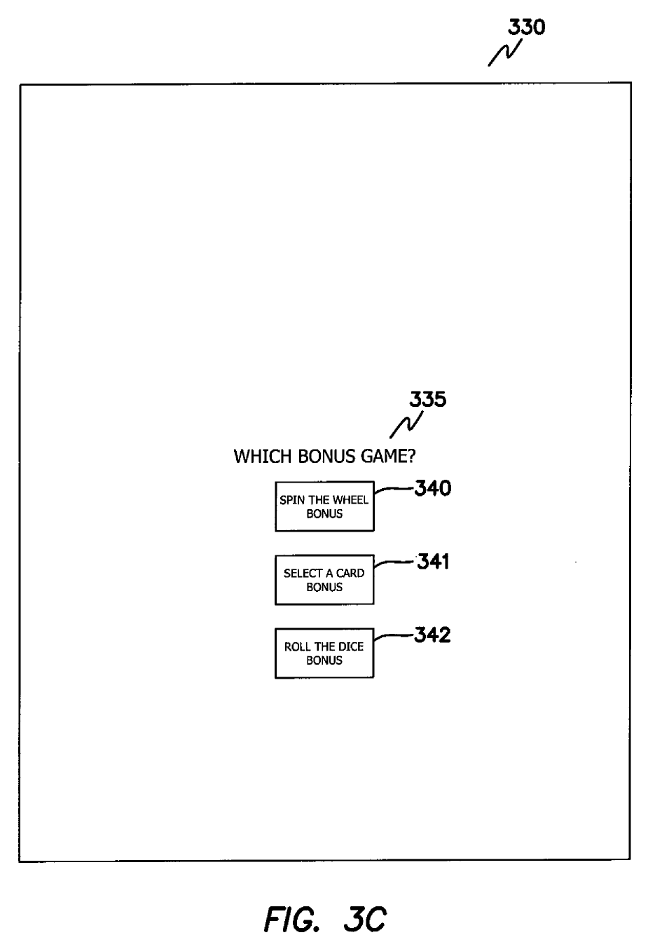

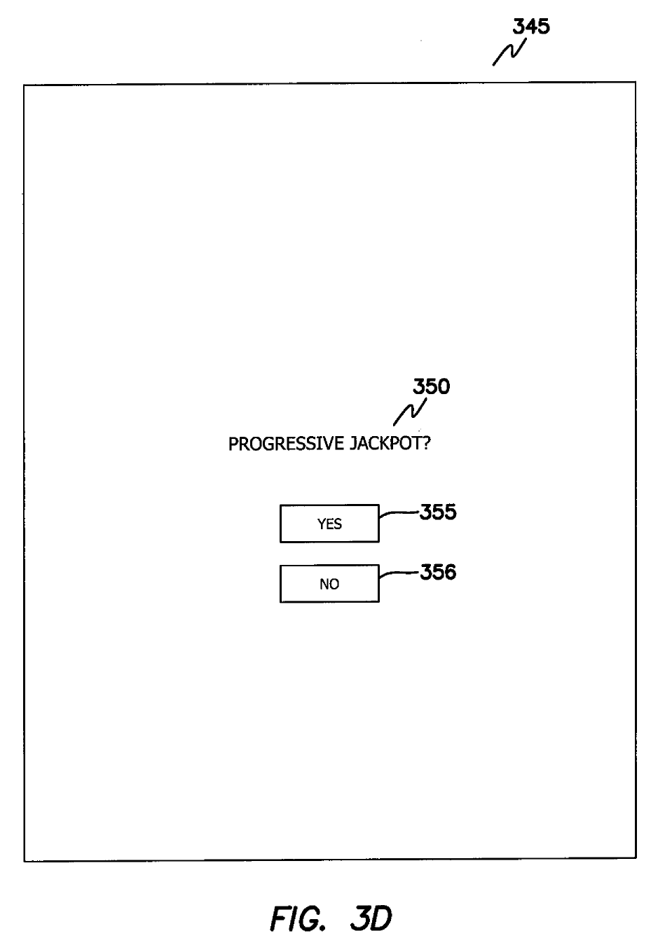

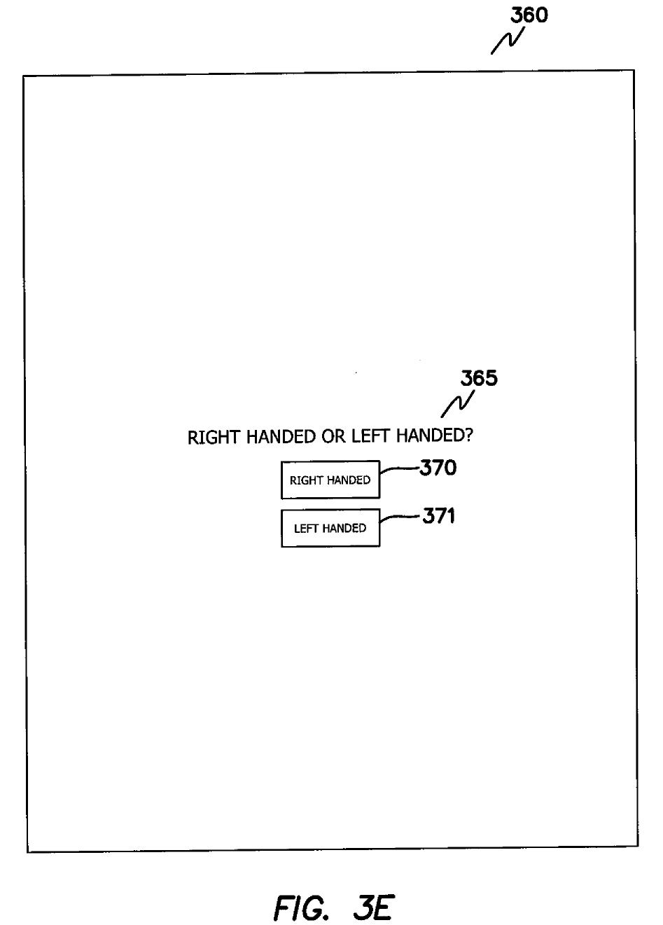

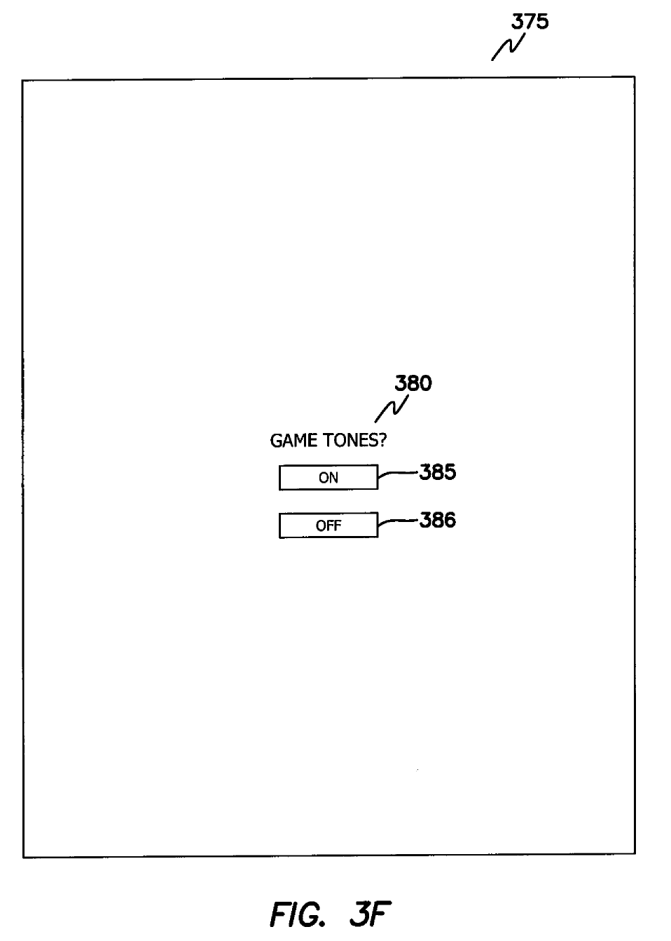

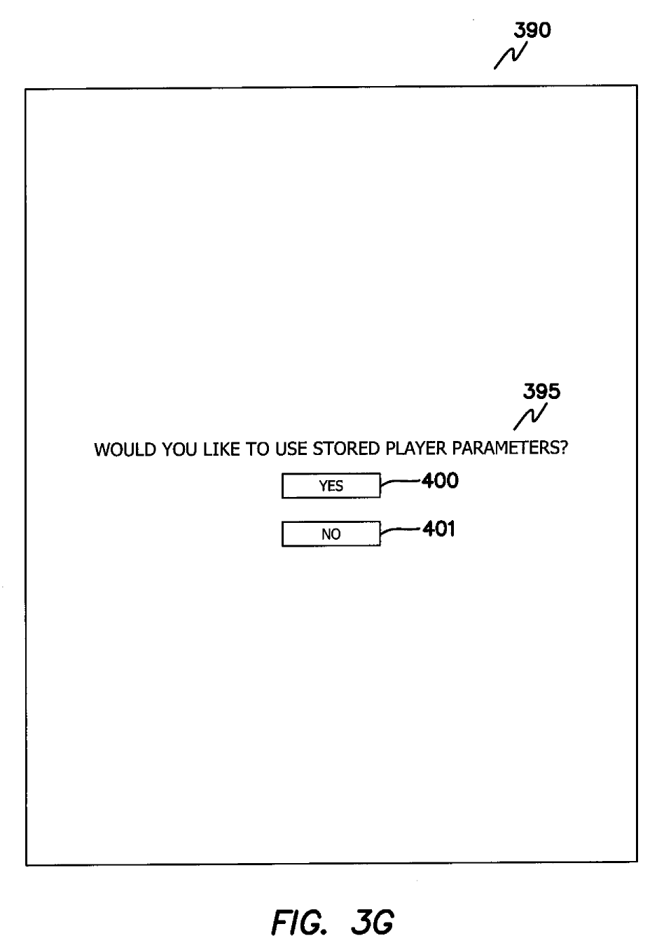

In a first embodiment of the present invention, a first player wager or insertion of a player card prompts the gaming machine, namely the processor, to query the player regarding his or her preferences related to game play. While the number and types of potential queries are numerous, FIGS. 3a through 3f focus on a representative sample. FIGS. 3a through 3f are directed to a video slot machine screen shots, wherein the queries are ideally presented via a game touch screen, but similar queries can be presented with any electronic gaming device. Moreover, the queries can be presented to players on a separate screen or device.

FIG. 3a shows a first screen shot 300 depicting a “NUMBER/CONFIGURATION OF PAY LINES?” query 305 and selection icons 310-314. Once the number of pay lines is selected, the player may also select which pay lines to activate. After the number and configuration of pay lines is selected by the player, a second screen shot 315, as shown in FIG. 3b, depicting a “NUMBER OF COINS PER SPIN?” query 320 and selection icons 325-329 is displayed. FIG. 3c shows a third screen shot 330 depicting a “WHICH BONUS GAME?” query 335 and selection icons 340-342. FIG. 3d shows a fourth screen shot 345 depicting a “PROGRESSIVE JACKPOT?” query 350 and selection icons 355, 356. FIG. 3e shows a fifth screen shot 360 depicting a “RIGHT HANDED OR LEFT HANDED?” query 365 and selection icons 370, 371. By selecting left-handed, game play icons may be presented on a left side of the machine screen and by selecting right-handed, game play icons may be presented on a right side of the machine screen. FIG. 3f shows a sixth screen shot 375 depicting a “GAME TONES?” query 380 and selection icons 385, 386. The player may also be permitted to select which game tones from a selection of game tones. Players may also be permitted to select whether or not to listen to music of their choice while playing the gaming device. The player may want to hear game tones or may not want to here them. Once all programmed queries have been presented and responded to, the player is ready to play the game.

In one embodiment, each of the responses entered by the player is stored in a player database associated with the player tracking system 230. Consequently, during a subsequent gaming session at the same type of machine, the stored parameters selected by the player are automatically reinstated once the player logs in using his or hr player card. Alternatively, as shown in screen shot 390 of FIG. 3g, the device may display a “WOULD YOU LIKE TO USE STORED PLAYER PARAMETERS?” query 395 and selection icons 400, 401. If the player presses the “No” icon 401, the player may be presented with each available query prior to the gaming session being initiated, otherwise, if the player presses the “Yes” icon 400 the stored parameters are reinstated. It is also possible that if the player selects the “No” icon 401 the game may be automatically configured using stored default parameters. Ideally, a player's database can store desired parameters associated with multiple machine types so that the player is able to play any game using preferred parameters.

Those skilled in the art will understand that any game features or functions may be offered to players and stored for later use and that those discussed above are exemplary. Those skilled in the art will further understand that a separate system apart from the player tracking system, can be utilized to store, and make available at future gaming sessions, the selected player parameters.

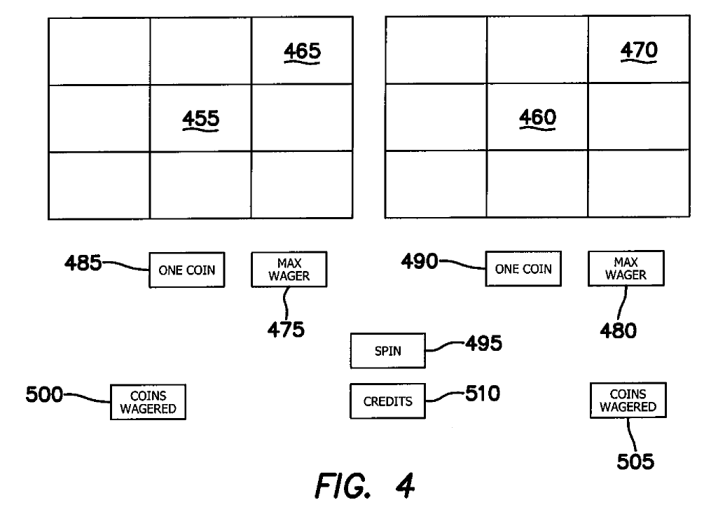

In another embodiment of the present invention, the player is able to select the option of playing multiple games simultaneously. As shown in FIG. 4, game screen 450 displays two 3-reel video slot games 455, 460 having nine symbol areas 465, 470. Pay lines (not shown) can take any suitable number and configuration, and as set forth above, can both be selected by the player. Players may use the game interface means, including maximum wager icons 475, 480, one coin icons 485, 490 and a spin icon 495, to wager and activate the slot games 455, 460. Wagers may be of an equal amount or different amounts on each slot game 455, 460. Once the wagers are placed, the games are initiated simultaneously via the spin icon 495. A pair of credits wagered icons 500, 505 (one for each game) and a total credits available icon 505 monitor player credits. Alternatively, there can be individual or separate available credit icons for each game. Accordingly, players are able to play two games 455, 460 at the same time. A single processor or multiple processors may be used to control the multiple games of chance. Such a configuration benefits the player by increasing the excitement level and providing an enhanced opportunity to win while benefiting the casino by increasing the money played and therefore the theoretical win of the casino. While two slot games are shown, it is conceivable that more than two slot games may be displayed on a game screen and played simultaneously. It is also conceivable that unique slot games or unique non-slot games or combinations thereof may be played simultaneously.

Although the invention has been described in detail with reference to several embodiments, additional variations and modifications exist within the scope and spirit of the invention as described and defined in the following claims.

I claim:

1. An electronic gaming device for playing a game of chance comprising:
a processor operable to control a game of chance;
means for permitting players to select certain preferred parameters associated with playing the game of chance on the electronic gaming device;
storage means in communication with the electronic gaming device wherein the storage means is operable to store selected preferred parameters; and
wherein the electronic gaming device may be automatically configured during each subsequent gaming session based on stored selected preferred parameters from a previous gaming session.

2. The electronic gaming device of claim 1 wherein the electronic gaming device is one of a plurality of networked electronic gaming devices.

3. The electronic gaming device of claim 1 wherein the storage means is associated with a player tracking system.

4. The electronic gaming device of claim 1 wherein said means for permitting the players to select certain preferred parameters associated with playing the game of chance on the electronic gaming device comprises touch screen technology.

5. The electronic gaming device of claim 1 wherein the parameters comprise game play functions and associated game features.

6. The electronic gaming device of claim 1 wherein the parameters for the player to select from include at least one of the following: a) number of pay lines; b) configuration of pay lines; c) left or right handed; d) bonus game configuration; e) whether to incorporate a progressive jackpot; f) whether to hear game tones; g) type of game tones; h) whether to hear music; and i) type of music.

7. The electronic gaming device of claim 1 wherein the processor is operable to automatically configure the electronic gaming device.

8. The electronic gaming device of claim 1 further comprising means for allowing the players to accept or decline automatic configuration of the electronic gaming device during each subsequent gaming session based on stored selected preferred parameters from a previous gaming session.

9. A networked electronic gaming device system comprising:
a plurality of linked electronic gaming devices of the same type;
means for permitting players to select certain preferred parameters associated with playing a game of chance on any one of the electronic gaming devices;
storage means in communication with each electronic gaming device wherein the storage means is operable to store selected preferred parameters; and
wherein any one of the electronic gaming devices may be automatically configured during each subsequent gaming session based on stored selected preferred parameters from a previous gaming session.

10. The system of claim 9 wherein the storage means is associated with a player tracking system.

11. The system of claim 9 wherein said means for permitting the players to select certain preferred parameters associated with playing the game of chance on any one of the electronic gaming devices comprises touch screen technology.

12. The system of claim 9 wherein the parameters comprise game play functions and associated game features.

13. The system of claim 9 wherein electronic gaming device processors are operable to automatically configure the electronic gaming devices.

14. The system of claim 9 further comprising prompting means for allowing the players to accept or decline automatic configuration of the electronic gaming device during each subsequent gaming session based on stored selected preferred parameters from a previous gaming session.

15. The system of claim 9 wherein the parameters for the player to select from include at least one of the following: a) number of pay lines; b) configuration of pay lines; c) left or right handed; d) bonus game configuration; e) whether to incorporate a progressive jackpot; f) whether to hear game tones; g) type of game tones; h) whether to hear music; and i) type of music.

16. A method of configuring a gaming device comprising:
offering a game of chance via an electronic gaming device;
permitting players to select certain preferred parameters associated with playing the game of chance on the electronic gaming device;
storing selected preferred parameters associated with the players; and
causing the electronic gaming device to be automatically configured during each subsequent gaming session based on stored selected preferred parameters from a previous gaming session.

17. The method of claim 16 further comprising linking multiple same type electronic gaming devices to a common central computer or server.

18. The method of claim 16 further comprising utilizing storage means associated a player tracking system to store selected preferred parameters associated with players.

19. The method of claim 16 further comprising utilizing touch screen technology to permit players to select said certain preferred parameters associated with playing the game of chance on the electronic gaming device.

20. The method of claim 16 further comprising utilizing an electronic gaming device processor to automatically configure the electronic gaming device.

21. The method of claim 16 further comprising permitting the player to select parameters from a list including at least one of the following: a) number of pay lines; b) configuration of pay lines; c) left or right handed; d) bonus game configuration; e) whether to incorporate a progressive jackpot; f) whether to hear game tones; g) type of game tones; h) whether to hear music; and i) type of music.

22. A method of configuring a gaming device comprising:
offering a game of chance via an electronic gaming device;
permitting players to select certain preferred parameters associated with playing the game of chance on the electronic gaming device;
storing selected preferred parameters associated with the players; and
providing the players with the option of selecting to automatically configure the electronic gaming device during each subsequent gaming session based on stored selected preferred parameters from a previous gaming session.

23. The method of claim 22 further comprising linking multiple same type electronic gaming devices to a common central computer or server.

24. The method of claim 22 further comprising utilizing storage means associated a player tracking system to store selected preferred parameters associated with players.

25. The method of claim 22 further comprising utilizing touch screen technology to permit players to select said certain preferred parameters associated with playing the game of chance on the electronic gaming device and select to automatically configure the electronic gaming device.

26. The method of claim 22 further comprising utilizing an electronic gaming device processor to automatically configure the electronic gaming device.

27. The method of claim 22 further comprising configuring the electronic gaming device according to default parameters in response to a player declining automatic configuration of the electronic gaming device during each subsequent gaming session based on stored selected preferred parameters from a previous gaming session.

28. The method of claim 22 further comprising permitting the player to select parameters from a list including at least one of the following: a) number of pay lines; b) configuration of pay lines; c) left or right handed; d) bonus game configuration; e) whether to incorporate a progressive jackpot; f) whether to hear game tones; g) type of game tones; h) whether to hear music; and i) type of music.

29. An electronic gaming device for playing a game of chance comprising:
one or more processors operable to control multiple games of chance;
displaying multiple games of chance on a game screen;
means for accepting wagers based on outcomes of multiple games of chance;
means for activating said games of chance simultaneously; and
means for providing payouts associated with outcomes of multiple games of chance played simultaneously.

30. The gaming device of claim 29 further comprising means for a player to select the option of playing multiple games of chance.

31. The gaming device of claim 29 further comprising means for a player to select how many games of chance to play simultaneously.

32. The gaming device of claim 29 further comprising means for a player to select which games to play simultaneously.

33. A method of conducting a game of chance comprising:
accepting wagers on multiple games of chance;
providing means for activating said multiple games of chance simultaneously; and
providing payouts relative to outcomes of each said multiple game of chance.

34. The method of claim 33 further comprising providing means for a player to select the option of playing multiple games of chance.

35. The method of claim 33 further comprising providing means for a player to select how many games of chance to play simultaneously.

36. The method of claim 33 further comprising providing means for a player to select which games to play simultaneously.
